(19) United States
(12) Patent Application Publication
(10) Pub. No.: US 2012/0099499 A1
(43) Pub. Date: Apr. 26, 2012

(54) METHOD AND APPARATUS FOR TRANSMITTING MULTICAST DATA IN BROADBAND WIRELESS COMMUNICATION SYSTEM

(75) Inventors: Jae-Hyuk JANG, Suwon-si (KR); Jung-Shin PARK, Seoul (KR); Jung-Je SON, Yongin-si (KR)

(73) Assignee: SAMSUNG ELECTRONICS CO. LTD., Suwon-si (KR)

(21) Appl. No.: 13/276,583

(22) Filed: Oct. 19, 2011

(30) Foreign Application Priority Data
Oct. 22, 2010 (KR) 10-2010-0103310

(51) Int. Cl. H04W 4/06; H04W 72/04; H04W 52/02

(52) U.S. Cl. 370/311; 370/312

(57) ABSTRACT

A method of operating a base station and an apparatus for transmitting multicast data in a broadband wireless communication system are provided. The method includes receiving multicast data including a multicast Internet Protocol (IP) address from a source terminal, the multicast IP address being an address used in a network layer, and transmitting the multicast data to at least one terminal by including the multicast IP address to a control message of a Media Access Control (MAC) layer. The sending of the MAC layer control message including the multicast IP address includes, when a corresponding terminal is in an idle mode, sending a paging message including at least part of the multicast IP address, after sending the paging message, sending a resource allocation MAP message for multicast transmission including at least part of the multicast IP address, and transmitting the multicast data based on the resource allocation MAP message.

### PRIORITY

The present application claims the benefit under 35 U.S.C. §119(a) of a Korean patent application filed in the Korean Intellectual Property Office on Oct. 22, 2010, and assigned Serial No. 10-2010-0103310, the entire disclosure of which is hereby incorporated by reference.

### BACKGROUND OF THE INVENTION

1. Field of the Invention

The present invention relates to a broadband wireless communication system. More particularly, the present invention relates to a method and an apparatus for transmitting multicast data in a broadband wireless communication system.

2. Description of the Related Art

Internet Protocol (IP) multicast technique is devised to transmit the same data to a plurality of receivers over the Internet. When a source transmits data, the IP multicast technique sets a destination address to a multicast IP address, rather than to an IP address of each terminal. When a terminal for receiving the multicast data sends a join message indicating to receive data of the multicast IP address, to a router which forwards a packet, the corresponding router replicates and transmits the data to terminals joining a multicasting group.

Meanwhile, there are several methods for sending data in a wireless communication system. Every data transmission and reception has unique address architecture per system. For example, typically, Ethernet (wired Local Area Network (LAN)) converts the multicast IP address to a 48-bit Media Access Control (MAC) address and Wireless-Fidelity (Wi-Fi) (wireless LAN) converts the multicast IP address to a 48-bit MAC address.

Accordingly, since the destination address of the multicast IP data is the multicast IP address rather than the IP address of a particular terminal, a separate MAC address is used rather than the MAC address of the particular terminal. That is, 01:00:5e:00:00:00-01:00:5e:7f:ff:ff of 48 bits is used as an address area, the higher 24 bits of the address use 01:00:5e, and the lower 24 bits use 00:00:00-7f:ff:ff replicates the multicast IP address of the data. The 32-bit multicast IP address of Internet Protocol version 4 (IPv4) is 24 bits in length except for the common higher 4 bits 0b1110, and accordingly, the 4-bit duplicated address is used.

Meanwhile, as another example of the wireless communication system, a system based on the Institute of Electrical and Electronics Engineers (IEEE) 802.16e standard uses 16-bit Connection IDentifier (CID) to identify the terminal, and a system based on IEEE 802.16m uses 12-bit Station IDentifier (STID) to identify the terminal.

However, since the 16-bit or 12-bit address is mostly used to identify the terminal, the address to allocate for the multicast data is insufficient.

In addition, even when a new ID (e.g., a multicast group ID) is adopted for the multicast data, another complicated management method is required to manage the terminals in a sleep mode or an idle mode.

Therefore, a need exists for a method and an apparatus for efficiently transmitting multicast data to a terminal of a sleep mode or an idle mode in a broadband wireless communication system.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for effectively transmitting multicast data to every terminal (including terminals in a sleep mode or an idle mode) in a broadband wireless communication system.

According to an aspect of the present invention, an operating method of a base station for transmitting multicast data in a broadband wireless communication system is provided. The method includes receiving multicast data including a multicast Internet Protocol (IP) address from a source terminal, the multicast IP address being an address used in a network layer, and transmitting the multicast data to at least one terminal by including the multicast IP address to a control message of a Media Access Control (MAC) layer.

According to another aspect of the present invention, an operating method of a terminal for transmitting multicast data in a broadband wireless communication system is provided. The method includes receiving a control message of a MAC layer including a multicast IP address from a base station, the multicast IP address being an address used in a network layer, and receiving the multicast data based on the multicast IP address.

According to yet another aspect of the present invention, an apparatus of a base station for transmitting multicast data in a broadband wireless communication system is provided. The apparatus includes a receiver for receiving multicast data including a multicast IP address from a source terminal, the multicast IP address being an address used in a network layer, and a controller for transmitting the multicast data to at least one terminal by including the multicast IP address to a control message of a MAC layer.

According to still another aspect of the present invention, an apparatus of a terminal for transmitting multicast data in a broadband wireless communication system is provided. The apparatus includes a controller for receiving a control message of a MAC layer including a multicast IP address from a base station, the multicast IP address being an address used in a network layer, and for receiving the multicast data based on the multicast IP address.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A through 1C illustrate a system for transmitting multicast data according to exemplary embodiments of the present invention;

FIG. 2 is a flowchart of a method for transmitting multicast data in a broadband wireless communication system according to an exemplary embodiment of the present invention;

FIG. 3 is a flowchart of base station operations for transmitting multicast data in a broadband wireless communication system according to an exemplary embodiment of the present invention;

FIG. 4 is a flowchart of terminal operations for transmitting multicast data in a broadband wireless communication system according to an exemplary embodiment of the present invention; and

FIG. 5 is a block diagram of an apparatus for transmitting multicast data in a broadband wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a method and an apparatus for transmitting multicast data in a broadband wireless communication system.

When a base station transmits multicast data, a resource allocation message (e.g., a MAP message) including all or part of a multicast Internet Protocol (IP) address is transmitted so that only terminals receiving the particular multicast address receive the corresponding data. When transmitting paging to terminals of an idle mode, the base station transmits information of the multicast data using a paging message and transmits the data to the terminals using the resource allocation message. Hence, the terminals receive the multicast data without a separate network entry process.

Hereinafter, exemplary embodiments of the present invention consider a system based on the Institute of Electrical and Electronics Engineers (IEEE) 802.16 standard.

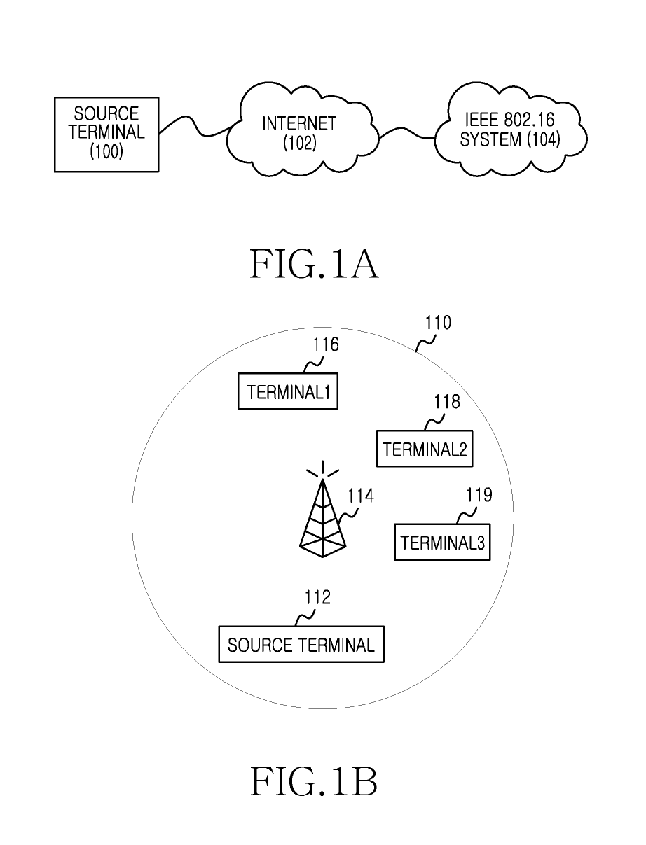

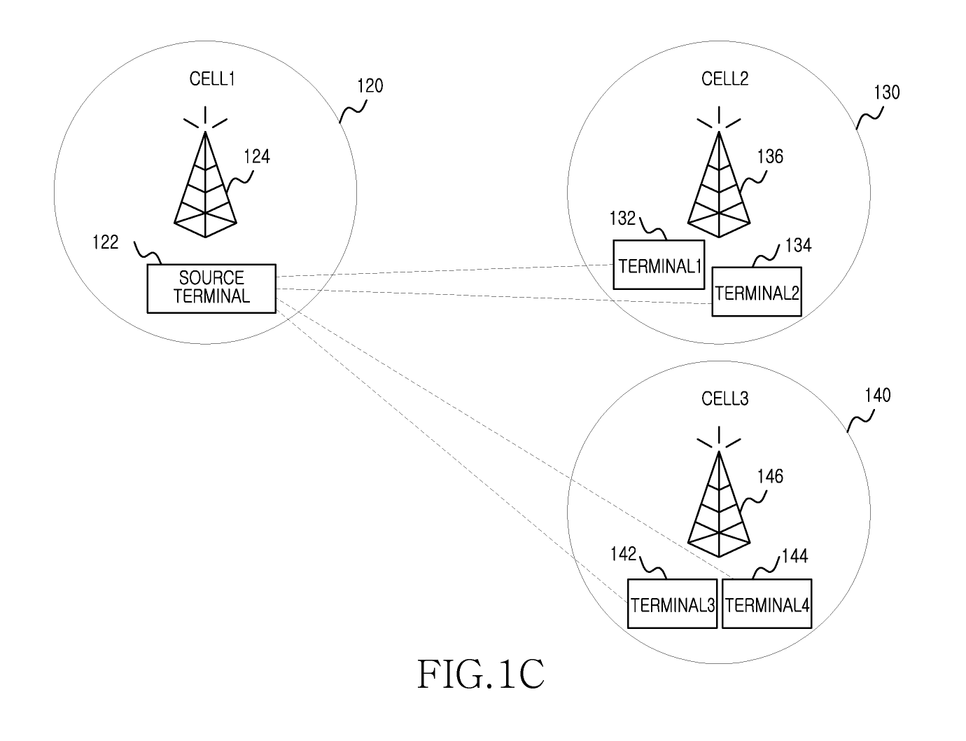

FIGS. 1A through 5, described below, and the various exemplary embodiments of the present invention provided are by way of illustration only and should not be construed in any way that would limit the scope of the present invention. Those skilled in the art will understand that the principles of the present disclosure may be implemented in any suitably arranged communications system. The terms used to describe various exemplary embodiments of the present invention provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIGS. 1A through 1C illustrate a system for transmitting multicast data according to exemplary embodiments of the present invention.

Referring to FIG. 1A, a source terminal 100 is an entity for transmitting multicast data to a plurality of destination terminals, and can employ one of a computer, a notebook computer, and a portable terminal connected to an Internet network 102. The destination terminals receiving the multicast data are connected to an IEEE 802.16 system 104.

Referring to FIG. 1B, a source terminal 112 is an entity for transmitting multicast data to a plurality of destination terminals 116, 118 and 119, and is serviced in one cell 110 of cells of the IEEE 802.16 system 104. The destination terminals 116, 118, and 119 receiving the multicast data are serviced by the same base station 114 as the source terminal 112.

Referring to FIG. 1C, a source terminal 122 is an entity for transmitting multicast data to a plurality of destination terminals 132, 134, 142 and 144, and is serviced by a base station 124 in one cell 120 of cells of the IEEE 802.16 system 104. Some destination terminals 132 and 134 receiving the multicast data are serviced by a base station 136 in the different cell 130 from the source terminal 122, and some destination terminals 142 and 144 receiving the multicast data are serviced by a base station 146 in the different cell 140 from the source terminal 122.

Hereafter, it is assumed that the destination terminals receiving the multicast data exist in the same cell as the source terminal, and the destination terminals receiving the multicast terminal belong to the same multicasting group. In various exemplary embodiments, one or more multicasting groups can exist in one cell.

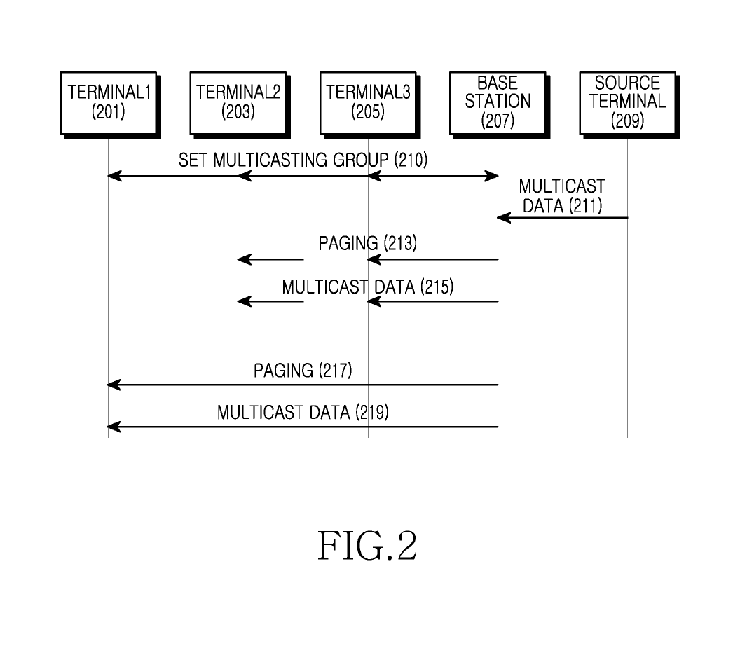

FIG. 2 is a flowchart of a method for transmitting multicast data in a broadband wireless communication system according to an exemplary embodiment of the present invention.

Referring to FIG. 2, a base station 207 and terminals 201, 203 and 205 determine the multicasting group based on Internet Group Management Protocol (IGMP) in step 210.

More specifically, when the base station 207 inquires the terminals 201, 203, and 205 about whether to receive the multicast data, the terminals 201, 203, and 205 send a response about whether to receive the multicast data. Hence, the base station 207 manages a multicast group list. Alternatively, other multicasting protocol than the IGMP protocol can be used.

Thereafter, upon receiving the multicast data from the source terminal 209 in step 211, the base station 207 forwards the multicast data by allocating resource based on connection state of the terminals 201, 203, and 205.

For example, when the terminals 201, 203, and 205 are in the idle mode and the first terminal 201 and the terminals 203 and 205 operate in different paging cycles, the base station 207 informs of the multicast data by sending a MOBile_PAGing_ADVertisement (MOB_PAG-ADV) message (see Table 1) including the multicast IP address to the second terminal 203 and the third terminal 205 at a time t1 in step 213.

TABLE 1

| Type | Length (bits) | Value | Scope |
|---|---|---|---|
| 1 | Variable, | (Full or partial) Multicast IP | MOB PAG- |
| | N_Multicast_Data x | address | ADV |
| | 28 | | |

Table 1 shows an example of the multicast IP address format in the paging message. The IEEE 802.16e based system uses the MOB_PAG-ADV message to wake up the idle terminal, which is referred to as the paging. In so doing, the MAC address of the corresponding terminal is used for the unicast data. An exemplary embodiment of the present invention informs of the multicast data using the full 28-bit multicast IP address, or pages using partial multicast IP address (e.g., Least Significant Bit (LSB) 24 bits). That is, the multicast IP address used in the network layer is contained in the MOB_PAG-ADV message of the MAC layer.

In step 215, the base station 207 transmits the multicast data using the MAP message (see Table 2) for the multicast transmission. The second terminal 203 and the third terminal 205, which belong to the same paging group, can receive the data at the same time.

TABLE 2

| Syntax | Size(bit) | Notes |
|---|---|---|
| Multicast DownLink | | |
| (DL)_MAP_IE( ) { | | |
| Downlink Interval Usage | 4 | 0xE (to indicate Extended-2 DIUC) |
| Code (DIUC) | | |
| Extended-2 DIUC | 4 | 0xF (to indicate Extended-3 Uplink |
| | | Interval Usage Code (UIUC)) |
| Length | 8 | Length in bytes of the unspecified data |
| | | field plus the extended-3 DIUC field (10 |
| | | bytes in full Multicast IP address case) |
| Extended-3 DIUC | 4 | 0x1 (To indicate Multicast data |
| | | transmission) |
| (Full or Partial) Multicast | 28 | LSB 28 bits of Multicast IP address (in |
| IP address | | full Multicast IP address case) |
| Orthogonal Frequency | 8 | The offset of the OFDMA symbol in |
| Division Multiple Access | | which the burst starts |
| (OFDMA) Symbol offset | | |
| Subchannel offset | 6 | The lowest index OFDMA subchannel |
| | | used for carrying the burst |
| Boosting | 3 | 000: Normal (not boosted), 001: +6 dB, |
| | | 010: −6 dB, 011: +9 dB, 100: +3 dB, |
| | | 101: −3 dB, 110: −9 dB, 111: −12 dB, |
| No. OFDMA Symbols | 7 | The number of OFDMA symbols that are |
| | | used to carry the burst |
| No. Subchannels | 6 | The number of subchannels with |
| | | subsequent indexes, used to carry the |
| | | burst. |
| Repetition Coding | 2 | 0b00: No repetition coding |
| Indication | | 0b01: Repetition coding of 2 used |
| | | 0b10: Repetition coding of 4 used |
| | | 0b11: Repetition coding of 6 used |
| } | | |

That is, the MAP message includes the full 28-bit multicast IP address or the partial multicast IP address. When the terminal receives the resource allocation message, it can determine whether to receive the actual data.

Meanwhile, to transmit the multicast data to the first terminal 201 belonging to the different paging group, the base station 207 replicates the multicast data received in step 211 and sends the paging message (see Table 1) at the wakeup time t2 of the first terminal 201 in step 217, and transmits the same multicast data using the MAP message (see Table 2) for the multicast transmission in step 219.

In contrast, when the terminals 201, 203 and 205 operate in a connected mode, the base station 207 transmits the multicast data using the MAP message of Table 2 for the multicast transmission, without having to send the paging message of Table 1, that is, without the steps 213 and 217.

Now, an exemplary implementation using the IEEE 802.16m based system is described. While the base station 207 and the terminals 201, 203 and 205 operate in the same manner in the multicast data transmission, the MAP message (see Table 2) for the multicast transmission is inapplicable because the resource allocation message in the IEEE 802.16m is limited to 40 bits in size.

Thus, only the lower 16 bits of the full 28-bit multicast IP address are transmitted as the resource allocation message. Since 10 bits can be duplicated, an extended header is additionally attached to the data to avoid unnecessary data forwarding.

Table 3 shows Multicast DL_A-MAP_IE in the IEEE 802.16m, and Table 4 shows the extended header format to avoid the unnecessary data forwarding.

TABLE 3

| Syntax | Size(bit) | Notes |
|---|---|---|
| Multicast_DL_MAP_IE( ) | | |
| { | | |
| DIUC | 4 | 0xE (to indicate Extended-2 DIUC) |
| Extended-2 DIUC | 4 | 0xF (to indicate Extended-3 UIUC) |
| Length | 8 | Length in bytes of the unspecified data |
| | | field plus the extended-3 DIUC field (10 |
| | | bytes in full Multicast IP address case) |
| Extended-3 DIUC | 4 | 0x1 (To indicate Multicast data |
| | | transmission) |
| (Full or Partial) Multicast | 28 | LSB 28 bits of Multicast IP address (in |
| IP address | | full Multicast IP address case) |
| OFDMA Symbol offset | 8 | The offset of the OFDMA symbol in |
| | | which the burst starts |
| Subchannel offset | 6 | The lowest index OFDMA subchannel |
| | | used for carrying the burst |
| Boosting | 3 | 000: Normal (not boosted), 001: +6 dB, |
| | | 010: −6 dB, 011: +9 dB, 100: +3 dB, |
| | | 101: −3 dB, 110: −9 dB, 111: −12 dB, |
| No. OFDMA Symbols | 7 | The number of OFDMA symbols that are |
| | | used to carry the burst |
| No. Subchannels | 6 | The number of subchannels with |
| | | subsequent indexes, used to carry the |
| | | burst. |
| Repetition Coding | 2 | 0b00: No repetition coding |
| Indication | | 0b01: Repetition coding of 2 used |
| | | 0b10: Repetition coding of 4 used |
| | | 0b11: Repetition coding of 6 used |
| } | | |

TABLE 4

| Syntax | Size(bit) | Description/Notes |
|---|---|---|
| Multicast_Address_EH ( ) { | | |
| Type | 4 | 0b1010 (to indicate |
| | | Multicast_Address_EH) |
| Partial Multicast IP address | 10 | Most Significant Bit (MSB) |
| | | 10 bits of Multicast IP address |
| Reserved | 2 | For byte alignment |
| } | | |

Table 4 shows an exemplary extended header format including the multicast address of the present invention.

That is, the terminal receives the multicast data by combining the 10-bit multicast IP address of the extended header following the header in the actual data transmission, and the 18-bit multicast IP address of the Multicast DL_A-MAP_IE MAP message.

The multicast IP address format in the paging message of the IEEE 802.16m system is shown in Table 5.

TABLE 5

| | Attributes/Array | Size | | |
|---|---|---|---|---|
| M/O | of attributes | (bits) | Value/Note | Conditions |
| O | Multicast IP | Variable | The list of multicast IP | Present if |
| | address array | | address to be sent after | Multicast data |
| | [1..255] | | sending the AAI_PAG- | exists |
| | | | ADV message | |
| M | A) Multicast IP | 28 | Multicast IP address | |
| | address | | | |

In the IEEE 802.16m based system, AAI_PAG-ADV message is used to wake up the idle terminal, and the MAC address of the corresponding terminal is used for the unicast data. An exemplary embodiment of the present invention informs of the multicast data using the full 28-bit multicast IP address, or pages using the smaller value (e.g., LSB 24 bits). Accordingly, the multicast IP address array is contained in an AAI_PAG-ADV message.

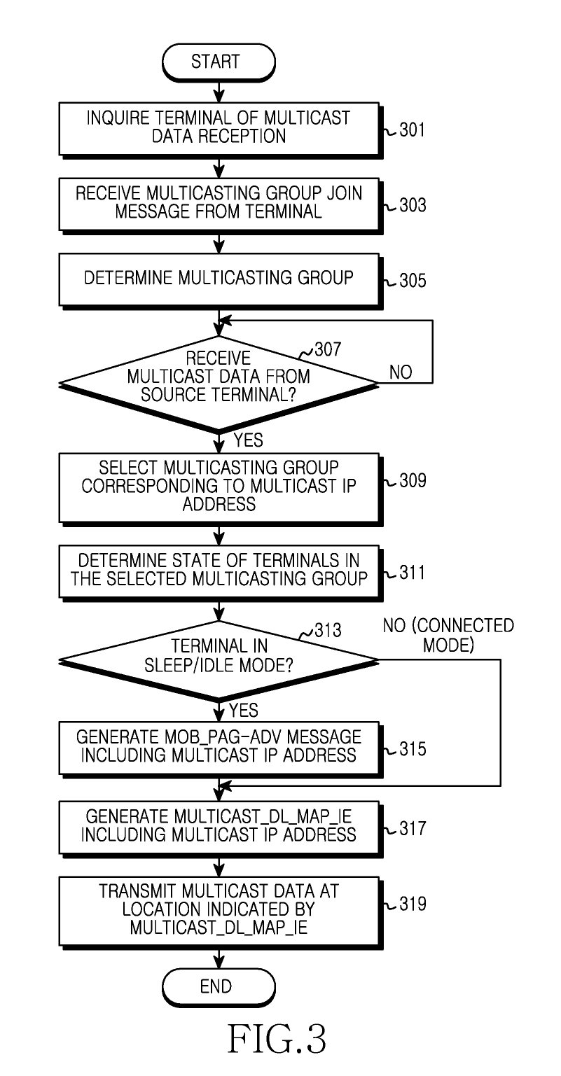

FIG. 3 is a flowchart of base station operations for transmitting multicast data in a broadband wireless communication system according to an exemplary embodiment of the present invention.

Referring to FIG. 3, a base station inquires terminals about whether to receive multicast data in step 301, and receives a multicasting group join message from the terminals in step 303.

In step 305, the base station determines the multicasting group based on the multicasting group join message from the terminals. That is, the base station manages the terminals joining the corresponding multicasting group, with the list.

When receiving the multicast data from the source terminal in step 307, the base station selects the multicasting group corresponding to the multicast IP address of the received multicast data in step 309.

Herein, the source terminal, which is the entity for transmitting the multicast data, can exist in the same cell as the terminals (see FIG. 1B) or in the different cell from the terminals (see FIG. 1C). In various exemplary implementations, the source terminal can reside in other system connected to the Internet network over the backbone (see FIG. 1A).

In step 311, the base station determines the state of the terminals in the selected multicasting group. That is, the base station determines whether the terminal of the selected multicasting group is in the idle mode or the connected mode.

When the terminal is in the idle mode or the sleep mode in step 313, the base station generates and sends the paging message (Table 1 or Table 5) including the multicast IP address, that is, the MOB_PAG-ADV message in the paging cycle in step 315. When the terminal is in the connected mode in step 313, the base station goes to step 317.

In step 317, the base station generates and sends the Multicast_DL_MAP_IE including the multicast IP address (refer to Table 2 in the IEEE 802.16e system, and Table 3 and Table 4 in the IEEE 802.16m system), and informs of the location of the multicast data to be received by the terminals.

In step 319, the base station transmits the multicast data at the location indicated by the Multicast_DL_MAP_IE.

Thereafter, the base station completes this process.

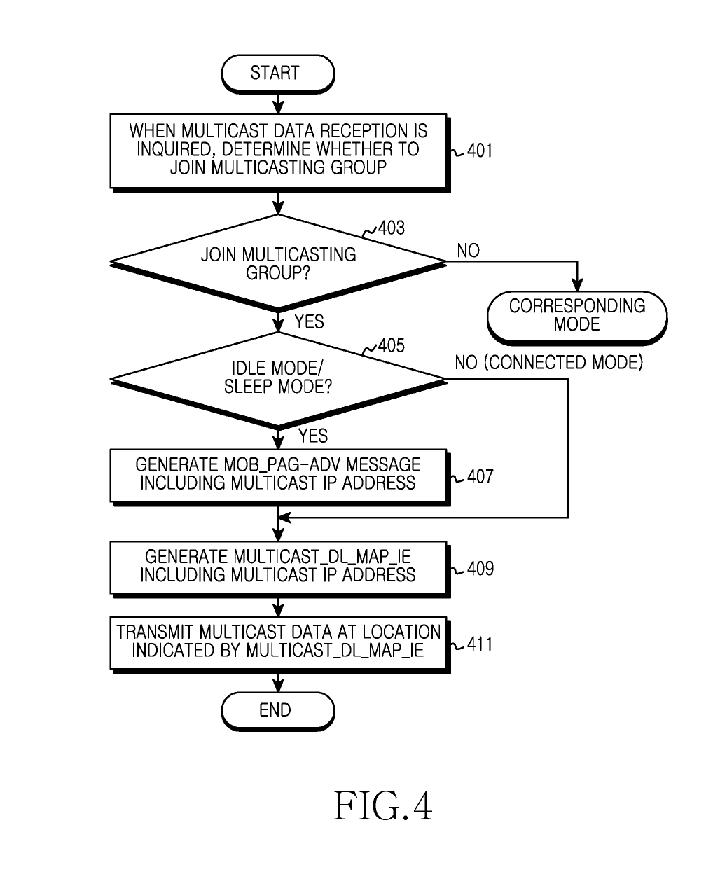

FIG. 4 is a flowchart of terminal operations for transmitting multicast data in a broadband wireless communication system according to an exemplary embodiment of the present invention.

Referring to FIG. 4, when a base station inquires about whether to receive multicast data, the terminal determines whether to join the multicasting group and informs of the determination in step 401.

When not joining the multicasting group in step 403, the terminal enters the corresponding mode. In the corresponding mode, the terminal can receive the unicast data or the multicast data.

In contrast, when joining the multicasting group, the terminal determines whether it is in the idle mode or in the sleep mode in step 405. In the idle mode or in the sleep mode, the terminal receives the MOB_PAG-ADV message including the multicast IP address in the corresponding paging cycle in step 407. In the connected mode, the terminal goes to step 409.

The terminal locates the multicast data by receiving the Multicast_DL_MAP_IE including the multicast IP address in step 409. By generating and sending the Multicast_DL_MAP_IE including the multicast IP address in step 411, the terminal receives the multicast data at the location indicated by the Multicast_DL_MAP_IE.

Thereafter, the terminal completes this process.

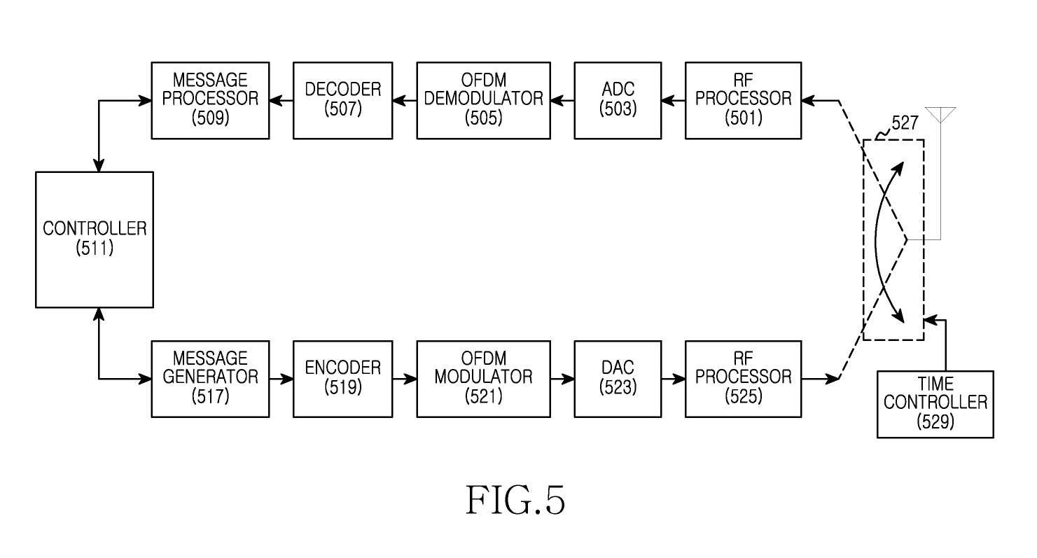

FIG. 5 is a block diagram of an apparatus for transmitting multicast data in a broadband wireless communication system according to an exemplary embodiment of the present invention. Herein, the apparatus is either a base station or a terminal.

Referring to FIG. 5, the terminal (or the base station) includes a Radio Frequency (RF) processor 501, an Analog/Digital Converter (ADC) 503, an Orthogonal Frequency Division Multiplexing (OFDM) demodulator 505, a decoder 507, a message processor 509, a controller 511, a message generator 517, an encoder 519, an OFDM modulator 521, a Digital/Analog Converter (DAC) 523, an RF processor 525, a Time Division Duplex (TDD) switch 527, and a time controller 529.

The TDD switch 527 controls switching operation based on frame synchronization. For example, in the signal reception interval, the TDD switch 527 controls the switch to connect an antenna and the RF processor 501 of the receiving stage. In the signal transmission interval, the TDD switch 527 controls the switch to connect the antenna and the RF processor 525 of the transmitting stage.

In the signal reception, the RF processor 501 converts an RF signal received over the antenna to a baseband analog signal. The ADC 503 converts the analog signal output from the RF processor 501 to sample data and outputs the sample data. The OFDM demodulator 505 outputs frequency-domain data by applying Fast Fourier Transform (FFT) to the sample data output from the ADC 503. The decoder 507 selects data of subcarriers to actually receive from the frequency-domain data output from the OFDM demodulator 505, and demodulates and decodes the selected data at a preset modulation level (Modulation and Coding Scheme (MCS) level)). The message processor 509 decomposes a control message fed from the decoder 507 and provides the result to the controller 511.

The controller 511 controls the base station or the terminal. The controller 511 processes information output from the message processor 509 and provides the result to the message generator 517.

The message generator 517 generates a message with the information provided from the controller 511 and outputs the generated message to the encoder 519 of the physical layer. The encoder 519 encodes and modulates the data output from the message generator 517 at the preset modulation level (MCS level). The OFDM modulator 521 outputs the sample data (OFDM symbols) by applying Inverse FFT (IFFT) to the data output from the encoder 519. The DAC 523 converts the sample data to an analog signal. The RF processor 525 converts the analog signal output from the DAC 523 to an RF signal and transmits the RF signal over the antenna.

In the base station, the controller 511 determines the multicasting group by inquiring the terminal about the multicast data reception.

By determining the state of the terminals in the multicasting group, the controller 511 generates or sends the message of Table 1 through Table 5 to the terminal to forward the multicast data received from the source terminal to the corresponding terminals.

For example, when the terminal is in the idle mode or the sleep mode, the controller 511 generates and sends the paging message (Table 1 or Table 5) including the multicast IP address, that is, the MOB_PAG-ADV message in the paging cycle, generates and sends the Multicast_DL_MAP_IE (see Table 2 for the IEEE 802.16e system, and Table 3 and Table 4 for the IEEE 802.16m system) including the multicast IP address, and informs of the location of the multicast data to be received by the terminals.

In the terminal, when the multicast data reception is inquired, the controller 511 determines whether to join the multicasting group and informs the base station of the determination. To receive the multicast data from the base station, in the idle mode or the sleep mode, the controller 511 receives the MOB_PAG-ADV message including the multicast IP address in the corresponding paging cycle, and locates the multicast data to receive by receiving the Multicast_DL_MAP_IE including the multicast IP address.

As set forth above, by use of the paging message including the multicast IP address, the terminals in the idle mode can receive the multicast data without a separate network entry process. Furthermore, there is no need to duplicate and transmit the multicast data by mapping the Connection IDentifier (CID) of every terminal in the multicasting group with the multicast IP address.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An operating method of a base station for transmitting multicast data in a broadband wireless communication system, the method comprising:
receiving multicast data including a multicast Internet Protocol (IP) address from a source terminal, wherein the multicast IP address is an address used in a network layer; and
transmitting the multicast data to at least one terminal by including the multicast IP address to a control message of a Media Access Control (MAC) layer.

2. The method of claim 1, wherein the transmitting of the multicast data to the at least one terminal comprises:
when receiving the multicast data including the multicast IP address from the source terminal, selecting at least one terminal to receive the multicast data;
determining a connection state of the at least one selected terminal and sending the control message of the MAC layer including the multicast IP address; and
transmitting the multicast data to at least one terminal based on the control message of the MAC layer.

3. The method of claim 2, wherein the determining of the connection state of the at least one selected terminal and the sending of the control message of the MAC layer including the multicast IP address comprise:
when a corresponding terminal is in an idle mode, sending a paging message including at least part of the multicast IP address;
after sending the paging message, sending a resource allocation MAP message for multicast transmission including at least part of the multicast IP address; and
transmitting the multicast data based on the resource allocation MAP message.

4. The method of claim 2, wherein the determining of the connection state of the at least one selected terminal and the sending of the control message of the MAC layer including the multicast IP address comprise:
when a corresponding terminal is in a connected mode, sending a resource allocation MAP message for multicast transmission including the multicast IP address; and
transmitting the multicast data based on the resource allocation MAP message.

5. The method of claim 2, wherein the determining of the connection state of the at least one selected terminal and the sending of the control message of the MAC layer including the multicast IP address comprise:
when a corresponding terminal is in an idle mode, sending a paging message including the multicast IP address;
after the sending of the paging message, sending a resource allocation MAP message for multicast transmission including part of the multicast IP address; and
sending an extended header including the remaining multicast IP address based on the resource allocation MAP message.

6. The method of claim 2, wherein the determining of the connection state of the at least one selected terminal and the sending of the control message of the MAC layer including the multicast IP address comprise:
when a corresponding terminal is in a connected mode, sending a resource allocation MAP message for multicast transmission including part of the multicast IP address; and
sending an extended header including the remaining multicast IP address based on the resource allocation MAP message.

7. The method of claim 1, further comprising:
setting a multicasting group for receiving the multicast data based on the multicast IP address.

8. An operating method of a terminal for transmitting multicast data in a broadband wireless communication system, the method comprising:
receiving a control message of a Media Access Control (MAC) layer including a multicast Internet Protocol (IP) address from a base station, wherein the multicast IP address is an address used in a network layer; and
receiving the multicast data based on the multicast IP address.

9. The method of claim 8, further comprising:
when the base station inquires about multicast data reception, sending a multicasting group join message to the base station.

10. The method of claim 8, wherein the receiving of the control message of the MAC layer comprising the multicast IP address comprises:
in an idle mode, receiving a paging message including at least part of the multicast IP address; and
after the receiving of the paging message, receiving a resource allocation MAP message for multicast transmission comprising at least part of the multicast IP address.

11. The method of claim 8, wherein the receiving of the control message of the MAC layer including the multicast IP address comprises:
when a corresponding terminal is in a connected mode, receiving a resource allocation MAP message for multicast transmission comprising the multicast IP address.

12. The method of claim 8, wherein the receiving of the control message of the MAC layer including the multicast IP address comprises:
when a corresponding terminal is in an idle mode, receiving a paging message comprising the multicast IP address;
after the receiving of the paging message, receiving a resource allocation MAP message for multicast transmission comprising part of the multicast IP address;
receiving an extended header comprising the remaining multicast IP address based on the resource allocation MAP message; and
combining the multicast IP address by combining the partial multicast IP address of the resource allocation MAP message and the remaining multicast IP address of the extended header.

13. The method of claim 8, wherein the receiving of the control message of the MAC layer including the multicast IP address comprises:
when a corresponding terminal is in a connected mode, receiving a resource allocation MAP message for multicast transmission comprising part of the multicast IP address;
receiving an extended header comprising the remaining multicast IP address based on the resource allocation MAP message; and
combining the multicast IP address by combining the partial multicast IP address of the resource allocation MAP message and the remaining multicast IP address of the extended header.

14. An apparatus of a base station for transmitting multicast data in a broadband wireless communication system, the apparatus comprising:
a receiver for receiving multicast data including a multicast Internet Protocol (IP) address from a source terminal, wherein the multicast IP address is an address used in a network layer; and
a controller for transmitting the multicast data to at least one terminal by including the multicast IP address to a control message of a Media Access Control (MAC) layer.

15. The apparatus of claim 14, wherein, the controller, when receiving the multicast data including the multicast IP address from the source terminal, selects at least one terminal to receive the multicast data, determines a connection state of the at least one selected terminal, sends the control message of the MAC layer comprising the multicast IP address, and transmits the multicast data to at least one terminal based on the control message of the MAC layer.

16. The apparatus of claim 15, wherein the controller, when a corresponding terminal is in an idle mode, sends a paging message comprising at least part of the multicast IP address, after the sending of the paging message, sends a resource allocation MAP message for multicast transmission including at least part of the multicast IP address, and transmits the multicast data based on the resource allocation MAP message.

17. The apparatus of claim 15, wherein the controller, when a corresponding terminal is in a connected mode, sends a resource allocation MAP message for multicast transmission including the multicast IP address, and transmits the multicast data based on the resource allocation MAP message.

18. The apparatus of claim 15, wherein the controller, when a corresponding terminal is in an idle mode, sends a paging message including the multicast IP address, after the sending of the paging message, sends a resource allocation MAP message for multicast transmission including part of the multicast IP address, and sends an extended header including the remaining multicast IP address based on the resource allocation MAP message.

19. The apparatus of claim 15, wherein the controller, when a corresponding terminal is in a connected mode, sends a resource allocation MAP message for multicast transmission including part of the multicast IP address, and sends an extended header including the remaining multicast IP address based on the resource allocation MAP message.

20. The apparatus of claim 14, wherein the controller sets a multicasting group for receiving the multicast data based on the multicast IP address.

21. An apparatus of a terminal for transmitting multicast data in a broadband wireless communication system, the apparatus comprising:
a controller for receiving a control message of a Media Access Control (MAC) layer including a multicast Internet Protocol (IP) address from a base station, the multicast IP address being an address used in a network layer, and for receiving the multicast data based on the multicast IP address.

22. The apparatus of claim 21, further comprising:
a transmitter for, when the base station inquires about multicast data reception, sending a multicasting group join message to the base station.

23. The apparatus of claim 21, wherein the controller, in an idle mode, receives a paging message including at least part of the multicast IP address, and
after the receiving of the paging message, the controller receives a resource allocation MAP message for multicast transmission including at least part of the multicast IP address.

24. The apparatus of claim 21, wherein the controller, when a corresponding terminal is in a connected mode, receives a resource allocation MAP message for multicast transmission including the multicast IP address.

25. The apparatus of claim 21, wherein the controller, when a corresponding terminal is in an idle mode, receives a paging message including the multicast IP address, after the receiving of the paging message, receives a resource allocation MAP message for multicast transmission including part of the multicast IP address, receives an extended header including the remaining multicast IP address based on the resource allocation MAP message, and combines the multicast IP address by combining the partial multicast IP address of the resource allocation MAP message and the remaining multicast IP address of the extended header.

26. The apparatus of claim 21, wherein the controller, when a corresponding terminal is in a connected mode, receives a resource allocation MAP message for multicast transmission including part of the multicast IP address, receives an extended header comprising the remaining multicast IP address based on the resource allocation MAP message, and combines the multicast IP address by combining the partial multicast IP address of the resource allocation MAP message and the remaining multicast IP address of the extended header.
